(19) United States
(12) Patent Application Publication
(10) Pub. No.: US 2026/0286753 A1
(43) Pub. Date: Sep. 24, 2026

(54) CLIP ASSEMBLIES FOR VEHICLES

(71) Applicant: DT MANUFACTURING ONE LLC, Highland, MI (US)

(72) Inventors: Michael Denton, Brighton, MI (US); Glenn Sprague, Brighton, MI (US)

(21) Appl. No.: 19/561,224

(22) Filed: Mar. 9, 2026

Related U.S. Application Data
(60) Provisional application No. 63/770,288, filed on Mar. 11, 2025.

(51) Int. Cl. E05C 17/54

(52) U.S. Cl. CPC E05C 17/54

(57) ABSTRACT

Clip assemblies for vehicles are disclosed. An apparatus includes a plate including a first surface and a second surface opposite the first surface, a through hole, a fastener, a first end, and a second end. The through hole extends through the plate between the first surface and the second surface. The fastener is coupled to the plate by a frangible coupling and is positioned within the through hole. The first end includes a first plate extension including a pair of first spacers extending from the first surface. The second end includes a second plate extension including a pair of second spacers extending from the first surface. A standoff extends substantially perpendicularly from the second surface of the plate and includes an extension extending from the first end of the plate and including a substantially consistent width along a top face of the extension. A clip is coupled to the standoff.

### RELATED APPLICATION SECTION

This application claims the benefit of and priority to U.S. Provisional Patent Application No. 63/770,288, filed Mar. 11, 2025, the content of which is incorporated by reference herein in its entirety and for all purposes.

### FIELD OF THE DISCLOSURE

The present disclosure relates to clip assemblies and, more particularly, to clip assemblies for vehicles.

### BACKGROUND

Spacers may be used to keep doors ajar when painting a vehicle.

U.S. Pat. No. 8,047,581 relates to temporary closing devices for temporarily holding closed vehicle components such as a door. The temporary closing device (10) of the '581 patent includes a plastic body (11) including a limit stop element (18) at a first end of the plastic body (11) and a resilient tongue (19) extending above the plastic body (11). A plate (20) is formed beneath the tongue (19) and an arch (21) is connected between the middle of the tongue (19) and the plate (20). The plate (20) is suspended above the plastic body (11). The closure device (10) of the '581 patent is shown being hollow in FIG. 6C and having a through hole 11d directly behind the limit stop element (18) in FIG. 3C.

U.S. Pat. No. 8,117,717 relates to temporary closing devices for temporarily holding closed vehicle components such as a door, hood, or tailgate. The temporary closing device of the '717 patent includes a fixing plate (2) and an abutment (4) that extends perpendicularly from the fixing plate (2). The abutment (4) includes a base (11) and a cylindrical head (12) that is attached to the base (11) by a narrowing cross-section that forms a throttle region. The throttle region provides the head (12) lateral flexibility on both sides of the longitudinal axis of the abutment (4), and longitudinal flexibility along the longitudinal axis of the abutment (4). The rounded cross-section of the head (12) provides distribution of stress during impact with the opening element. The temporary closing device and the abutment (4) of the '717 patent are shown being hollow in all figures.

It would be desirable to provide a more robust clip assembly.

### SUMMARY

The disclosed implementations relate to clip assemblies for vehicles that include an extension having substantially parallel sides and/or a consistent width that increases robustness. An end of the extension on the clip assemblies may have a rectangular front face. The face being rectangular as opposed to being rounded increases the surface area and accounts for manufacturing tolerances and/or misalignments that may otherwise affect the ability of the front face from impacting the surface defining a latch pocket/fish mouth of a door as intended. The clip assemblies may be solid molded further increasing robustness.

The clip assemblies disclosed may include a rear extension that is configured to deter the clip assemblies from rocking and/or rotating rearwardly when the clip assemblies are impacted in use. The rear extension may be sized to enable flexibility and reduce the likelihood of breaking.

In a first implementation, an apparatus includes a plate, a standoff, and a clip. The plate includes a first surface and a second surface opposite the first surface, a through hole, a fastener, a first end, and a second end. The through hole extends through the plate between the first surface and the second surface. The fastener is coupled to the plate by a frangible coupling and positioned within the through hole. The first end includes a first plate extension including a pair of first spacers extending from the first surface. The second end includes a second plate extension including a pair of second spacers extending from the first surface. The standoff extends substantially perpendicularly from the second surface of the plate and includes an extension extending from the first end of the plate and including a substantially consistent width. The clip includes a base and a flexible arm. The base is coupled to the standoff and laterally overhangs the standoff. The flexible arm is coupled to the base and includes a lead-on ramp.

In a second implementation, an apparatus includes a plate, a standoff, and a clip. The plate includes a first surface and a second surface opposite the first surface, a through hole, a fastener, a first end, and a second end. The through hole extends through the plate between the first surface and the second surface. The fastener is coupled to the plate by a frangible coupling and is positioned within the through hole. The first end includes a first plate extension including a pair of first spacers extending from the first surface. The second end includes a second plate extension including a pair of second spacers extending from the first surface. The standoff extends substantially perpendicularly from the second surface of the plate and includes an extension extending from the first end of the plate and including a substantially consistent width along a top face of the extension. The clip is coupled to the standoff.

In a third implementation, an apparatus, comprising: a plate, a standoff, and a clip. The plate includes a first surface and a second surface opposite the first surface, a through hole, a fastener, a first, and a second end. The through hole extending through the plate between the first surface and the second surface. The fastener is coupled to the plate by a frangible coupling and positioned within the through hole. The standoff extends substantially perpendicularly from the second surface of the plate and includes an extension extending from the first end of the plate and including substantially parallel side surfaces. The clip is coupled to the standoff.

In further accordance with the foregoing first, second, and/or third implementations, an apparatus and/or method may further comprise or include any one or more of the following:

In an implementation, the standoff includes a solid molded standoff.

In another implementation, the extension includes a rectangular front face.

In another implementation, the extension includes a rectangular bottom face and a rectangular top face.

In another implementation, the bottom face is substantially perpendicular to the front face.

In another implementation, the top face includes a draft angle to enable manufacturability.

In another implementation, the extension includes substantially parallel side faces.

In another implementation, the side faces include a draft angle to enable manufacturability.

In another implementation, the extension includes side faces that include a draft angle to enable manufacturability.

In another implementation, the extension includes a trapezoidal frustrum.

In another implementation, a surface of the standoff and a surface of the base of the clip are coplanar and substantially perpendicular to the plate.

In another implementation, the second surface of the plate at the second plate extension is coplanar to an area of the second surface of the plate surrounding the standoff.

In another implementation, the extension, the first plate extension, and the second plate extension are symmetric along a longitudinal axis.

In another implementation, further including a post extending from the second surface of the plate.

In another implementation, the post and the fastener are substantially equally spaced from the first end, the second end, and a longitudinal axis of the plate.

In another implementation, the standoff includes a trapezoidal frustrum extending substantially perpendicularly from the second surface of the plate and coupled to and opposing the extension.

In another implementation, further including a second through hole extending through the plate between the first surface and the second surface and a second fastener coupled to the plate by a frangible coupling and positioned within the second through hole.

In another implementation, the fastener and the second fastener are substantially equally spaced from the first end, the second end, and a longitudinal axis of the plate.

In another implementation, the clip includes a skeleton frame clip.

In another implementation, the skeleton frame clip includes a first flexible arm, a second flexible arm, and a lead-in ramp coupled between the first flexible arm and the second flexible arm.

In another implementation, the clip includes a flexible arm including a lead-in ramp.

In another implementation, a surface of the standoff and a surface of the clip include a continuous arched contour.

In another implementation, further including a step between the second plate extension and the second surface of the plate.

In another implementation, the clip includes a base coupled to the standoff and a flexible arm coupled to the base and including a lead-in ramp.

In another implementation, the side surfaces being substantially parallel includes the side surfaces including a draft angle to enable manufacturability.

In another implementation, the side surfaces being substantially parallel includes the side surfaces including a draft angle to enable manufacturability.

In another implementation, the extension includes a coring.

### BRIEF DESCRIPTION OF THE DRAWINGS

FIG. 1 is an isometric front view of an example clip assembly in accordance with the teachings of this disclosure.

FIG. 2 is another isometric front view of the clip assembly of FIG. 1.

FIG. 3 is an isometric rear view of the clip assembly of FIG. 1.

FIG. 4 is a side view of the clip assembly of FIG. 1 that shows the surface of the standoff and the surface of the base of the clip being coplanar and substantially perpendicular to the plate.

FIG. 5 is a bottom plan view of the clip assembly of FIG. 1.

FIG. 6 is an isometric view of the clip assembly of FIG. 1 in the process of being installed in mounting holes of a B-pillar of a vehicle frame.

FIG. 7 is an isometric view of the clip assembly of FIG. 1 with the post positioned in the mounting hole of the B-pillar of the vehicle frame.

FIG. 8 is an isometric view of the clip assembly of FIG. 1 with the fastener screwed into the mounting hole and the post positioned in the mounting hole of the B-pillar.

FIG. 9 is an isometric view of the clip assembly of FIG. 1 prior to being positioned within a latch pocket of a vehicle door.

FIG. 10 is an isometric view of the clip assembly of FIG. 1 positioned within the latch pocket of the vehicle door.

FIG. 11 is an isometric view of another example clip assembly in accordance with the teaching of this disclosure.

FIG. 12 is a bottom plan view of the clip assembly of FIG. 12.

FIG. 13 is an isometric view of another example clip assembly in accordance with the teachings of this disclosure.

FIG. 14 is a rear isometric view of the clip assembly of FIG. 13.

FIG. 15 is a rear isometric view of another example clip assembly.

FIG. 16 is a rear isometric view of another example clip assembly.

### DETAILED DESCRIPTION

The disclosed implementations relate to clip assemblies for vehicles.

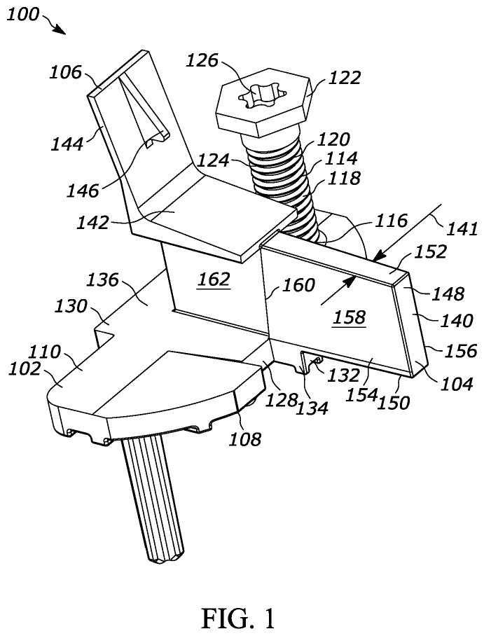

FIG. 1 is an isometric front view of an example clip assembly 100 in accordance with the teachings of this disclosure. The clip assembly 100 of FIG. 1 includes a plate 102, a standoff 104, and a clip 106.

The plate 102 includes a first surface 108 and a second surface 110 opposite the first surface 108. A through hole 112 extends through the plate 102 between the first surface 108 and the second surface 110 and a fastener 114 is coupled to the plate 102 by a frangible coupling 116. The fastener 114 is shown positioned within the through hole 112. The fastener 114 is implemented by a bolt 118 having a bolt body 120 and a bolt head 122. The bolt body 120 has threads 124 and the bolt head 122 has a hexalobular or star-headed design 126. The fastener 114 may be implemented in different ways and/or the bolt head 122 may have a different recess that is configured to be driven by another drive system.

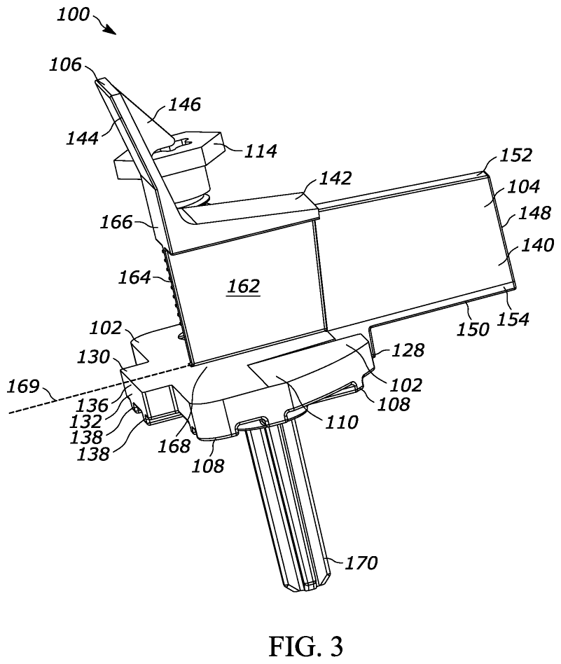

The plate 102 has a first end 128 and a second end 130. The first end 128 includes a first plate extension 132 including a pair of first spacers 134 extending from the first surface 108. The second end 130 includes a second plate extension 136 including a pair of second spacers 138 (see, FIG. 3) extending from the first surface 108. The spacers 134, 138 may facilitate manufacturability and/or reduce contact area between the clip assembly 100 and a vehicle to which the clip assembly 100 is configured to be attached.

The standoff 104 extends substantially perpendicularly from the second surface 110 of the plate 102 and includes an extension 140 extending from the first end 128 of the plate 102. The extension 140 has a substantially consistent width 141 in the implementation shown. The extension 140 may be referred to as a bump stop. The extension 140 may form a polyhedron. As set forth herein the phrase “substantially consistent width” accounts for draft angles and/or manufacturing tolerances and includes a consistent width itself. The draft angles may be included to enable the clip assembly 100 to be removed from a mold during an injection molding process, for example. A draft angle may be between about 0.5° and about 3°, as an example. As set forth herein, substantially perpendicular accounts for draft angles and/or manufacturing tolerances and includes perpendicular itself. The extension 140 may have a substantially consistent cross-section as shown. As set forth herein, the phrase “substantially consistent cross-section” accounts for draft angles and/or manufacturing tolerances and includes a consistent cross-section itself.

The clip 106 includes a base 142 and a flexible arm 144. The base 142 is coupled to the standoff 104 and laterally overhanging the standoff 104. The flexible arm 144 is coupled to the base 142 and has a lead-In ramp 146.

The standoff 104 is formed as a solid molded standoff 147 in the implementation shown. The solid molded standoff 147 is more robust as compared to if the standoff 104 were instead hollow. The standoff 104 and/or the extension 140 may alternatively be hollow molded.

The extension 140 includes a rectangular front face 148. The rectangular front face 148 provides additional surface area for the surface of the car to engage when propping the vehicle door open to account for misalignment and/or manufacturing tolerances. Less surface may be provided if, for example, the front of the extension 140 were instead rounded. The front of the extension 140 being rounded may be referred to as a semicircular front face. The extension 140 includes a rectangular bottom face 150 and a rectangular top face 152. The bottom face 150 is substantially perpendicular to the front face 148. The extension 140 is shown having a substantially consistent width along the top face 152 of the extension 140.

The top face 152 has a draft angle to enable manufacturability. Thus, the top face 152 is shown not being perpendicular to the front face 148. For example, the top face 152 may be between about 0.5° and about 3°of perpendicular relative to the front face 148. The top face 152 may be at any other angle, however.

The extension 140 includes substantially parallel side faces 154, 156 in the implementation shown. The side faces 154, 156 include a draft angle to enable manufacturability. The draft angle may be about 0.5° and about 3° per side. For example, the draft angle may be about 0.5° and/or less than about 0.5° in the example shown. While the top face 152 and the side faces 154, 156 are mentioned having a draft angle to facilitate and/or enable manufacturability, one or more surfaces of the clip assembly 100 may include draft angles.

The extension 140 is shown as a trapezoidal frustrum 158 in the implementation shown. The front face 148, the top face 152, the bottom face 150, and the side faces 154, 156 may form a polyhedron, for example The polyhedron and/or the trapezoidal frustrum may be defined on one side by parting line 160.

The standoff 104 also includes a second trapezoidal frustrum 162 extending substantially perpendicularly from the second surface 110 of the plate 102 and coupled to and opposing the extension 140. The second trapezoidal frustrum 162 may include surfaces having draft angles to enable manufacturability. The standoff 104 may include alternative shapes, however.

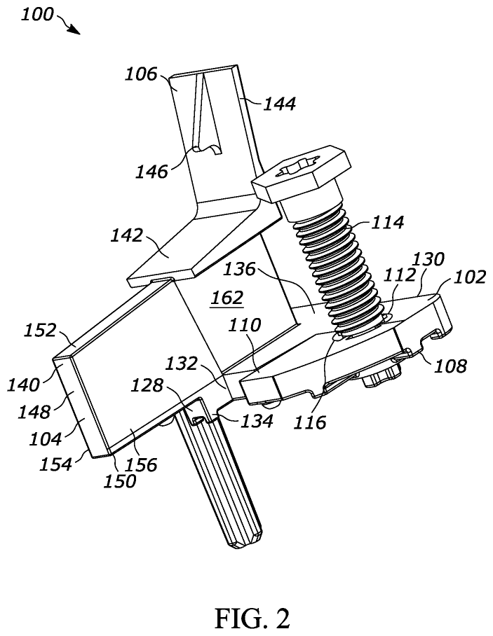

FIG. 2 is another isometric front view of the clip assembly 100 of FIG. 1.

FIG. 3 is an isometric rear view of the clip assembly 100 of FIG. 1. A surface 164 of the standoff 104 and a surface 166 of the base 142 of the clip 106 are shown coplanar and substantially perpendicular to the plate 102. The second surface 110 of the plate 102 at the second plate extension 136 is shown being coplanar to an area 168 of the second surface 110 of the plate 102 surrounding the standoff 104. The second plate 136 may deter the clip assembly 100 from rocking and/or rotating rearwardly when the extension 140 of the standoff 104 impacts a surface of a door in use, for example. The second plate extension 136 being coplanar with the area 168 may allow the second plate extension to have a reduced thickness. The second plate extension 136 may be relatively flexible and/or less likely of breaking in use as compared to if the second plate extension 136 where thicker. The extension 140, the first plate extension 132, and the second plate extension 136 are symmetric along a longitudinal axis 169 in the implementation shown.

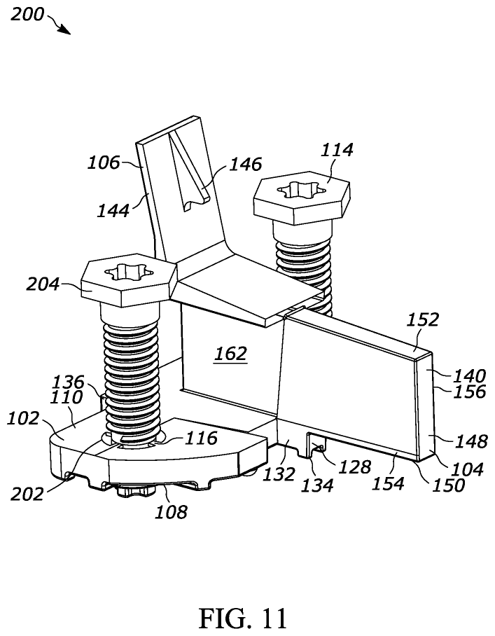

A post 170 is included extending from the second surface 110 of the plate 102 in the implementation shown. The post 170 may be positioned in one of a pair of mounting holes on a frame of a vehicle when mounting the clip assembly 100 to the vehicle. The frame having the mounting holes may be a B-pillar of a vehicle and/or a c-pillar of a vehicle. The B-pillar is the middle pillar in a vehicle frame between the front and rear doors and the C-pillar is behind the rear door and may connect the roof of the vehicle to the frame of the vehicle, for example. The clip assembly 100 is shown including the fastener 114 and the post 170. The clip assembly 100 may alternatively include two fasteners (see, FIG. 11). The clip assembly 100 may alternatively include two posts 170.

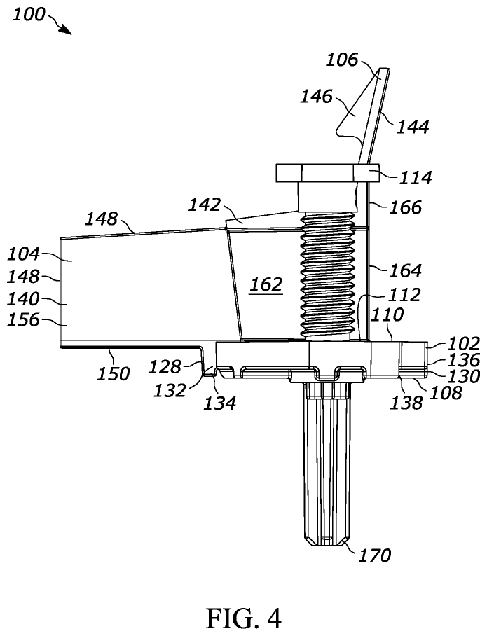

FIG. 4 is a side view of the clip assembly 100 of FIG. 1 that shows the surface 164 of the standoff 104 and the surface 166 of the base 142 of the clip 106 being coplanar and substantially perpendicular to the plate 102.

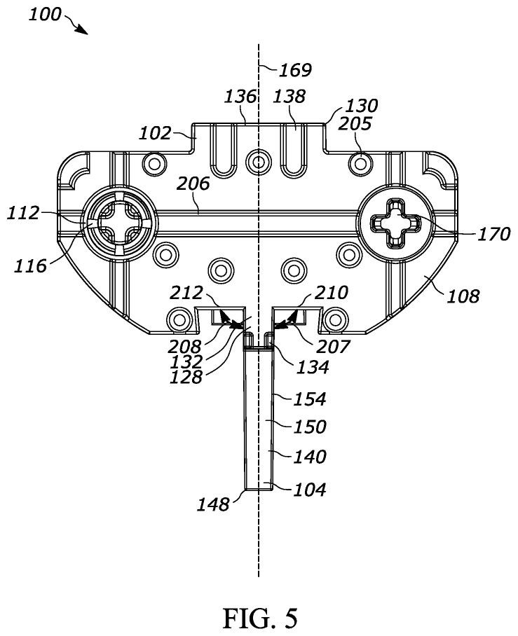

FIG. 5 is a bottom plan view of the clip assembly 100 of FIG. 1. The post 170 and the fastener 114 are substantially equally spaced from the first end 128, the second end 130, and the longitudinal axis 169 of the plate 102 in the implementation shown. The phrase “substantially equally spaced” accounts for manufacturing tolerances. The post 170 and/or the fastener 114 may be differently positioned than shown. The clip assembly 100 is shown including a plurality of additional spacers 205, 206. The spacers 205, 206 may facilitate manufacturability and/or reduce contact area between the clip assembly 100 and a vehicle to which the clip assembly 100 is configured to be attached. The spacers 205 and/or 206 may be differently located than shown or omitted. Angles 207, 208 between the side faces 154, 156 may be approximately 89.5°relative to surfaces 210, 212 of the plate 102 in the implementation shown. The draft angle may thus be about 0.5° to facilitate manufacturability. The angles 207, 208 may be different in other examples.

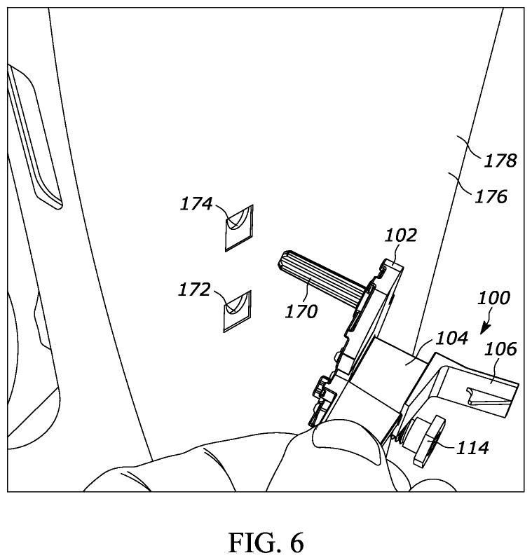

FIG. 6 is an isometric view of the clip assembly 100 of FIG. 1 in the process of being installed in mounting holes 172, 174 of a B-pillar 176 of a vehicle frame 178. The clip assembly 100 may be mounted to other areas of the car such as the C-Pillar of the vehicle frame 178. The clip assembly 100 may additionally or alternatively be mounted to a rear body panel at or adjacent the trunk lip.

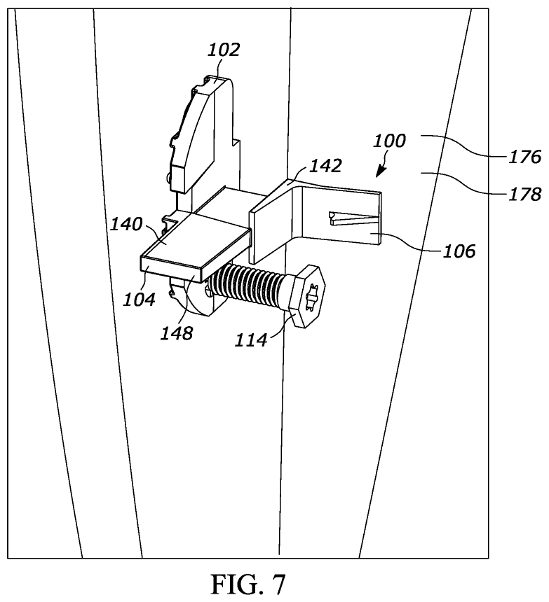

FIG. 7 is an isometric view of the clip assembly 100 of FIG. 1 with the post 170 positioned in the mounting hole 174 of the B-pillar 176 of the vehicle frame 178.

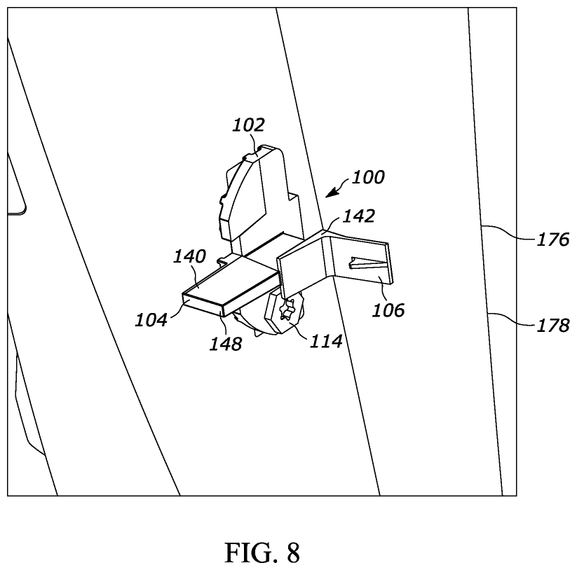

FIG. 8 is an isometric view of the clip assembly 100 of FIG. 1 with the fastener 114 screwed into the mounting hole 172 and the post 170 positioned in the mounting hole 174 of the B-pillar 176.

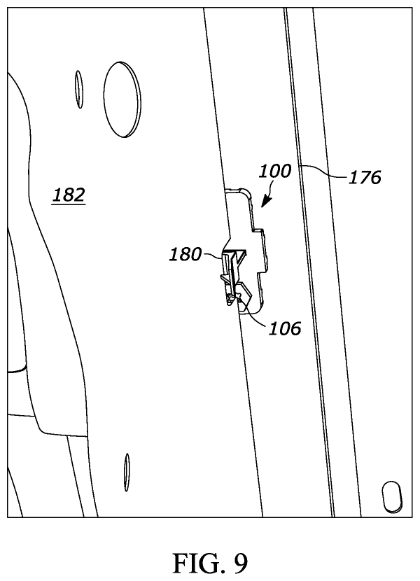

FIG. 9 is an isometric view of the clip assembly 100 of FIG. 1 prior to being positioned within a latch pocket 180 of a vehicle door 182. The latch pocket 180 may be referred to as a fish mouth.

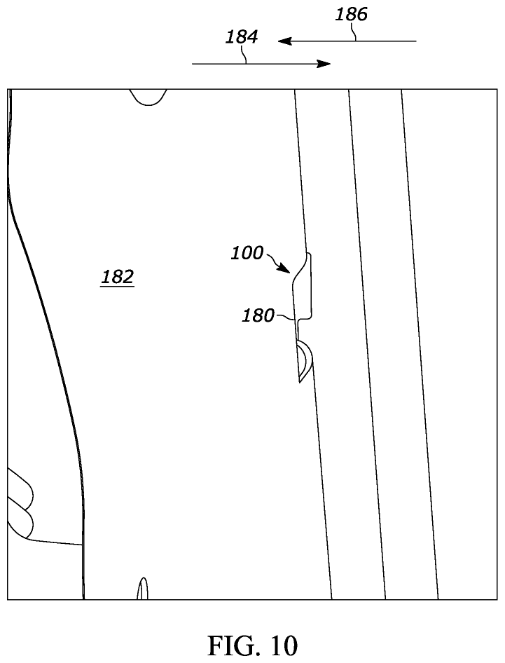

FIG. 10 is an isometric view of the clip assembly 100 of FIG. 1 positioned within the latch pocket 180 of the vehicle door 182. The front face 148 is configured to engage a surface of the vehicle door 182 to prevent the vehicle door 182 from further moving in a direction generally indicated by arrow 184. The clip 106 of the clip assembly 100 is configured to engage an inner surface of the vehicle door 182 surrounding the latch pocket 180 to deter the vehicle door 182 from inadvertently opening in a direction generally indicated by arrow 186. The vehicle door 182 may be physically pulled and/or opened in a direction generally indicated by the arrow 186 and elastically deforming the clip 106 to allow the clip 106 to be removed from the latch pocket 180.

FIG. 11 is an isometric view of another example clip assembly 200 in accordance with the teaching of this disclosure. The clip assembly 200 is substantially the same as the clip assembly 100 of FIG. 1. The clip assembly 200 of FIG. 11 does not include the post 170 in the implementation shown. The clip assembly 200 includes a second through hole 202 and a second fastener 204. The second through hole 202 extends through the plate 102 between the first surface 108 and the second surface 110 and the second fastener 204 is coupled to the plate 102 by a frangible coupling 116 and positioned within the second through hole 202.

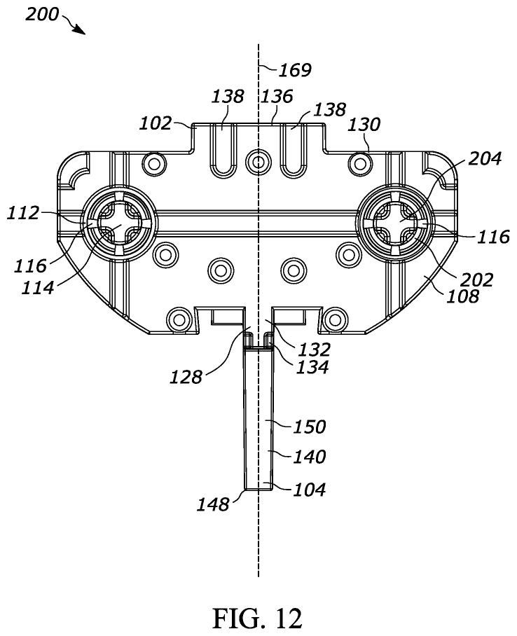

FIG. 12 is a bottom plan view of the clip assembly 200 of FIG. 12. The fasteners 114, 204 are substantially equally spaced from the first end 128, the second end 130, and the longitudinal axis 169 of the plate 102 in the implementation shown.

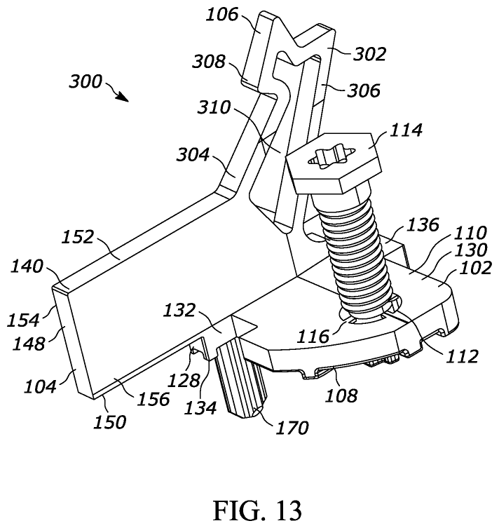

FIG. 13 is an isometric view of another example clip assembly 300 in accordance with the teachings of this disclosure. The clip assembly 300 of FIG. 13 is similar to the clip assembly 100 of FIG. 1. The clip assembly 300 however includes a skeleton frame clip 302. The skeleton frame clip 302 includes a first flexible arm 304, a second flexible arm 306, and a lead-in ramp 308 coupled between the first flexible arm 304 and the second flexible arm 306 in the implementation shown. The skeleton frame clip 302 includes a cutout 310. The first flexible arm 304 extends rearward from the top face 152 and the second arm 306 extends rearward of the surface 164 of the standoff 104. The clip assembly 300 includes the fastener 114 and the post 170. The clip assembly 300 may alternatively include two fasteners 114, 204 and/or two posts 170.

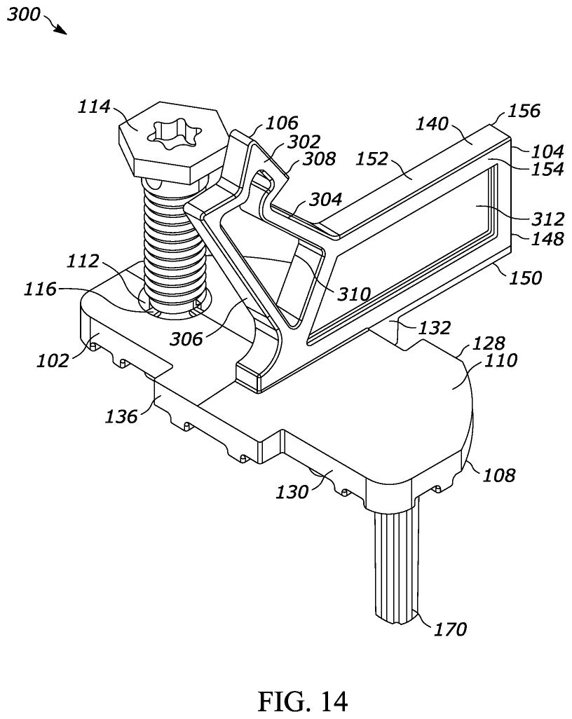

FIG. 14 is a rear isometric view of the clip assembly 300 of FIG. 13. The extension 104 includes a coring 312 in the implementation shown. The coring 312 reduces an amount of material used when forming the clip assembly 300. The cutout 312 may alternatively be omitted. The coring 312 is positioned beneath the side surfaces 154, 156 in the implementation shown. The side surfaces 154, 156 are shown being substantially parallel. The extension 140 is shown having a substantially consistent width along the top face 152 of the extension 140.

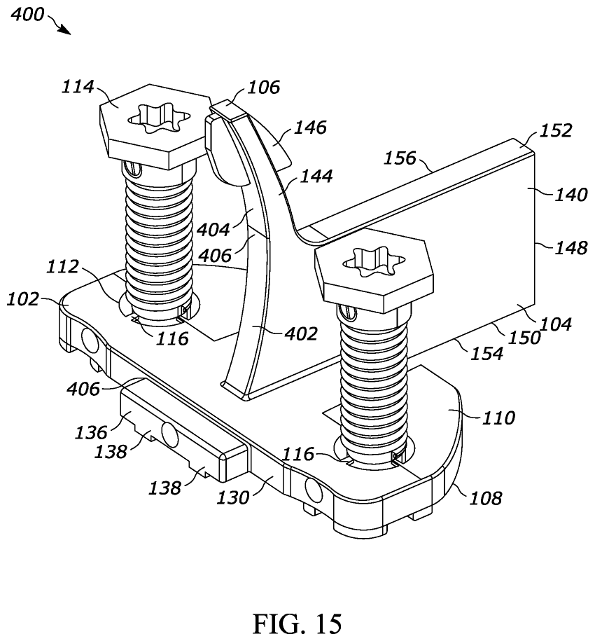

FIG. 15 is a rear isometric view of another example clip assembly 400. The clip assembly 400 of FIG. 15 is similar to the clip assembly 200 of FIG. 11. The clip assembly 400 of FIG. 15 has a surface 402 of the standoff 104 and a surface 404 of the clip 106 that form a continuous arched contour 406. A step 406 between the second plate extension 136 and the second surface 110 of the plate 102 is included in the implementation shown. The step 406 may alternatively be omitted.

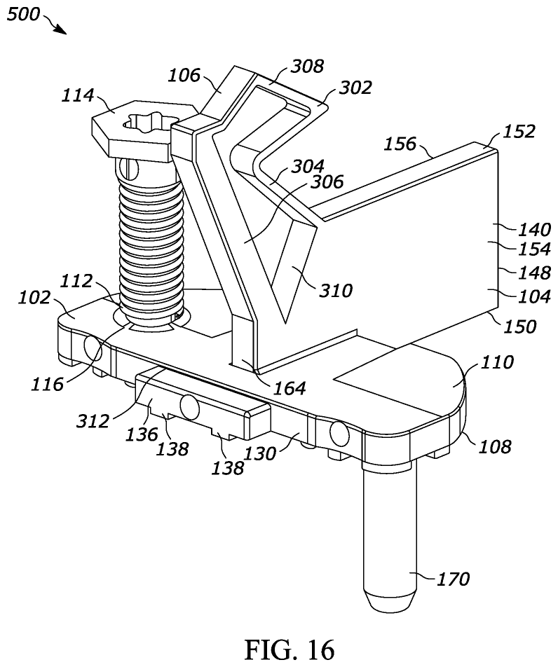

FIG. 16 is a rear isometric view of another example clip assembly 500. The clip assembly 500 of FIG. 16 is similar to the clip assembly 300 of FIG. 13 but the cutout 312 is omitted.

### EXAMPLES OF COMBINATIONS

Example 1. An apparatus, comprising: a plate, comprising: a first surface and a second surface opposite the first surface; a through hole extending through the plate between the first surface and the second surface; a fastener coupled to the plate by a frangible coupling and positioned within the through hole; a first end comprising a first plate extension comprising a pair of first spacers extending from the first surface; and a second end comprising a second plate extension comprising a pair of second spacers extending from the first surface; a standoff extending substantially perpendicularly from the second surface of the plate and comprising an extension extending from the first end of the plate and comprising a substantially consistent cross-section; a clip, comprising: a base coupled to the standoff and laterally overhanging the standoff; and a flexible arm coupled to the base and comprising a lead-on ramp.

Example 2. The apparatus of Example 1, wherein the standoff includes a solid molded standoff.

Example 3. The apparatus of any one of the preceding Examples, wherein the extension includes a rectangular front face.

Example 4. The apparatus of Example 3, wherein the extension includes a rectangular bottom face and a rectangular top face.

Example 5. The apparatus of Example 4, wherein the bottom face is substantially perpendicular to the front face.

Example 6. The apparatus of any one of Examples 4-5, wherein the top face includes a draft angle to enable manufacturability.

Example 7. The apparatus of any one of the preceding Examples, wherein the extension includes substantially parallel side faces.

Example 8. The apparatus of Example 7, wherein the side faces include a draft angle to enable manufacturability.

Example 9. The apparatus of any one of the preceding Examples, wherein the extension includes side faces that include a draft angle to enable manufacturability.

Example 10. The apparatus of any one of the preceding Examples, wherein the extension includes a trapezoidal frustrum.

Example 11. The apparatus of any one of the preceding Examples, wherein a surface of the standoff and a surface of the base of the clip are coplanar and substantially perpendicular to the plate.

Example 12. The apparatus of any one of the preceding Examples, wherein the second surface of the plate at the second plate extension is coplanar to an area of the second surface of the plate surrounding the standoff.

Example 13. The apparatus of any one of the preceding Examples, wherein the extension, the first plate extension, and the second plate extension are symmetric along a longitudinal axis.

Example 14. The apparatus of any one of the preceding Examples, further comprising a post extending from the second surface of the plate.

Example 15. The apparatus of Example 14, wherein the post and the fastener are substantially equally spaced from the first end, the second end, and a longitudinal axis of the plate.

Example 16. The apparatus of any one of the preceding Examples, wherein the standoff includes a trapezoidal frustrum extending substantially perpendicularly from the second surface of the plate and coupled to and opposing the extension.

Example 17. The apparatus of any one of Examples 1-14, further comprising: a second through hole extending through the plate between the first surface and the second surface; a second fastener coupled to the plate by a frangible coupling and positioned within the second through hole.

Example 18. The apparatus of Example 17, wherein the fastener and the second fastener are substantially equally spaced from the first end, the second end, and a longitudinal axis of the plate.

Example 19. An apparatus, comprising: a plate, comprising: a first surface and a second surface opposite the first surface; a through hole extending through the plate between the first surface and the second surface; a fastener coupled to the plate by a frangible coupling and positioned within the through hole; a first end comprising a first plate extension comprising a pair of first spacers extending from the first surface; and a second end comprising a second plate extension comprising a pair of second spacers extending from the first surface; a standoff extending substantially perpendicularly from the second surface of the plate and comprising an extension extending from the first end of the plate and comprising a substantially consistent cross-section along a top face of the extension; and a clip coupled to the standoff.

Example 20. The apparatus of Example 19, wherein the clip includes a skeleton frame clip.

Example 21. The apparatus of Example 20, wherein the skeleton frame clip includes a first flexible arm, a second flexible arm, and a lead-in ramp coupled between the first flexible arm and the second flexible arm.

Example 22. The apparatus of Example 19, wherein the clip includes a flexible arm comprising a lead-in ramp.

Example 23. The apparatus of Example 19, wherein a surface of the standoff and a surface of the clip include a continuous arched contour.

Example 24. The apparatus of any one of Examples 19-23, further comprising a step between the second plate extension and the second surface of the plate.

Example 25. The apparatus of Example 19, wherein the clip includes: a base coupled to the standoff; and a flexible arm coupled to the base and comprising a lead-in ramp.

Example 26. An apparatus, comprising: a plate, comprising: a first surface and a second surface opposite the first surface; a through hole extending through the plate between the first surface and the second surface; a fastener coupled to the plate by a frangible coupling and positioned within the through hole; and a first end and a second end; a standoff extending substantially perpendicularly from the second surface of the plate and comprising an extension extending from the first end of the plate and comprising substantially parallel side surfaces; and a clip coupled to the standoff.

Example 27. The apparatus of Example 26, wherein the side surfaces being substantially parallel comprises the side surfaces comprising a draft angle to enable manufacturability.

Example 28. The apparatus of any one of Example 26-27, wherein the extension comprises a coring.

Example 29. The apparatus of any one of Examples 26-28, wherein the extension comprises a rectangular front face.

Example 30. The apparatus of any one of Examples 26-28, wherein the extension comprises a rounded front face.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

The following claims recite aspects of certain examples of the disclosed subject matter and are considered to be part of the above disclosure. These aspects may be combined with one another.

What is claimed is:

1. An apparatus, comprising:
a plate, comprising:
a first surface and a second surface opposite the first surface;
a through hole extending through the plate between the first surface and the second surface;
a fastener coupled to the plate by a frangible coupling and positioned within the through hole;
a first end comprising a first plate extension comprising a pair of first spacers extending from the first surface; and
a second end comprising a second plate extension comprising a pair of second spacers extending from the first surface;
a standoff extending substantially perpendicularly from the second surface of the plate and comprising an extension extending from the first end of the plate and comprising a substantially consistent width;
a clip, comprising:
a base coupled to the standoff and laterally overhanging the standoff; and
a flexible arm coupled to the base and comprising a lead-on ramp.

2. The apparatus of claim 1, wherein the standoff comprises a solid molded standoff.

3. The apparatus of claim 1, wherein the extension comprises a rectangular front face.

4. The apparatus of claim 3, wherein the extension comprises a rectangular bottom face and a rectangular top face.

5. The apparatus of claim 4, wherein the bottom face is substantially perpendicular to the front face.

6. The apparatus of claim 4, wherein the top face comprises a draft angle to enable manufacturability.

7. The apparatus of claim 1, wherein the extension comprises substantially parallel side faces.

8. The apparatus of claim 7, wherein the side faces being substantially parallel comprise a draft angle to enable manufacturability.

9. The apparatus of claim 1, wherein the extension comprises side faces that comprise a draft angle to enable manufacturability.

10. The apparatus of claim 1, wherein the extension comprises a trapezoidal frustrum.

11. The apparatus of claim 1, wherein a surface of the standoff and a surface of the base of the clip are coplanar and substantially perpendicular to the plate.

12. The apparatus of claim 1, wherein the second surface of the plate at the second plate extension is coplanar to an area of the second surface of the plate surrounding the standoff.

13. The apparatus of claim 1, wherein the extension, the first plate extension, and the second plate extension are symmetric along a longitudinal axis.

14. The apparatus of claim 1, further comprising a post extending from the second surface of the plate.

15. The apparatus of claim 14, wherein the post and the fastener are substantially equally spaced from the first end, the second end, and a longitudinal axis of the plate.

16. The apparatus of claim 1, wherein the standoff comprises a trapezoidal frustrum extending substantially perpendicularly from the second surface of the plate and coupled to and opposing the extension.

17. The apparatus of any claim 1, further comprising:
a second through hole extending through the plate between the first surface and the second surface; and
a second fastener coupled to the plate by a frangible coupling and positioned within the second through hole.

18. The apparatus of claim 17, wherein the fastener and the second fastener are substantially equally spaced from the first end, the second end, and a longitudinal axis of the plate.

19. An apparatus, comprising:
a plate, comprising:
a first surface and a second surface opposite the first surface;
a through hole extending through the plate between the first surface and the second surface;
a fastener coupled to the plate by a frangible coupling and positioned within the through hole;
a first end comprising a first plate extension comprising a pair of first spacers extending from the first surface; and
a second end comprising a second plate extension comprising a pair of second spacers extending from the first surface;
a standoff extending substantially perpendicularly from the second surface of the plate and comprising an extension extending from the first end of the plate and comprising a substantially consistent width along a top face of the extension; and
a clip coupled to the standoff.

20. The apparatus of claim 19, wherein the clip comprises a skeleton frame clip.

21. The apparatus of claim 20, wherein the skeleton frame clip comprises a first flexible arm, a second flexible arm, and a lead-in ramp coupled between the first flexible arm and the second flexible arm.

22. The apparatus of claim 19, wherein the clip comprises a flexible arm comprising a lead-in ramp.

23. The apparatus of claim 19, wherein a surface of the standoff and a surface of the clip comprise a continuous arched contour.

24. The apparatus of claim 19, further comprising a step between the second plate extension and the second surface of the plate.

25. The apparatus of claim 19, wherein the clip comprises:
a base coupled to the standoff; and
a flexible arm coupled to the base and comprising a lead-in ramp.

26. An apparatus, comprising:
a plate, comprising:
a first surface and a second surface opposite the first surface;
a through hole extending through the plate between the first surface and the second surface;
a fastener coupled to the plate by a frangible coupling and positioned within the through hole; and
a first end and a second end;
a standoff extending substantially perpendicularly from the second surface of the plate and comprising an extension extending from the first end of the plate and comprising substantially parallel side surfaces; and
a clip coupled to the standoff.

27. The apparatus of claim 26, wherein the side surfaces being substantially parallel comprises the side surfaces comprising a draft angle to enable manufacturability.

28. The apparatus of claim 26, wherein the extension comprises a coring.

29. The apparatus of claim 26, wherein the extension comprises a rectangular front face.

30. The apparatus of claim 26, wherein the extension comprises a rounded front face.
